(19) United States
(12) Patent Application Publication
(10) Pub. No.: US 2024/0383060 A1
(43) Pub. Date: Nov. 21, 2024

(54) Method Of Forming A Recess In A Workpiece

(71) Applicants: MTU AERO ENGINES AG, Munich (DE); EMAG GMBH & CO. KG, Salach (DE)

(72) Inventors: Alexander Noller, Salach (DE); Walter Rothammel, Salach (DE); Waldemar Ochs, Salach (DE); Anton Prieb, Salach (DE); Nicole Feiling, Munich (DE); Florian Karges, Munich (DE); Roland Huttner, Munich (DE); Gazmen Dzemajili, Munich (DE)

(21) Appl. No.: 18/704,172

(22) PCT Filed: Oct. 17, 2022
(86) PCT No.: PCT/EP2022/078811

§ 371 Date: Apr. 24, 2024

(30) Foreign Application Priority Data
Oct. 25, 2021 (EP) 21204403.6

(51) Int. Cl. B23H 3/04; B23H 9/14

(52) U.S. Cl. CPC B23H 3/04; B23H 9/14

(57) ABSTRACT

The present invention relates to a method for introducing a recess (3) into a workpiece (1), wherein the recess (3) is introduced with a processing cathode (2) by electrochemical ablation, wherein a flank (1.3) delimiting the recess (3) is exposed with the ablation, which flank extends from a first surface (1.1) of the workpiece (1) in the direction of an opposite second surface (1.2) of the workpiece (1), wherein a protective anode (7.1, 7.2) is arranged on at least one of the surfaces (1.1, 1.2) during removal, which protective anode is associated with the flank (1.3) and bears against the at least one surface (1.1, 1.2) in electrical contact with the workpiece (1), and wherein the protective anode (7.1, 7.2) is offset outwards relative to the flank (1.3), i.e. away from the recess (3).

### TECHNICAL AREA

The present invention relates to a method for forming a recess in a workpiece.

### STATE OF THE ART

The recess is formed by electrochemical machining (ECM), i.e. using a processing cathode, also known as an ECM cathode. This allows even comparatively hard materials to be machined, which is why it can be used in the manufacture of components for axial flow machines, particularly aircraft engines. In this respect, there may be special requirements in terms of, for example, the accuracy and reproducibility of workpiece machining.

This shall illustrate a preferred field of application, but shall not limit the generality upfront.

### REPRESENTATION OF THE INVENTION

The present invention shall solve the technical problem of providing a particularly advantageous method for forming a recess in a workpiece.

According to the invention, this is solved by the method according to claim 1. In this method, the recess is formed in a manner known per se with the processing cathode, i.e. a flank delimiting the recess is exposed by the removal, which flank extends from a first surface of the workpiece in direction to an opposite second surface thereof. According to the invention, a protective anode is arranged on at least one of these surfaces, i.e. on the first and/or second surface, which is in electrical contact with the at least one surface. The protective anode is offset laterally outwards, namely away from the recess, relative to the exposed flank laterally delimiting the recess. In other words, the protective anode is not aligned with the flank in the advance direction, but there is an offset between the flank and an edge of the protective anode facing the recess and resting against the at least one surface.

Considering a comparative case without a protective anode, at the edges of the flank, i.e. at the entry side between the flank and the first surface and at the exit side between the flank and the second surface, a densification of the electric field lines and consequently a local increase in the current density can result for geometrical reasons. The protective anode, which is provided with the workpiece at the same electrical potential, can therefore initially cause a more homogeneous distribution of the electric field lines, for example. Furthermore, by placing it not exactly in alignment but slightly offset from the flank, a rounding of the respective edge between the flank and the surface can then be specifically influenced or adjusted.

In somewhat simplified terms, a greater rounding can be achieved with a larger offset and a smaller rounding with a smaller offset, at least assuming otherwise identical removal behavior (see below in detail). Compared to other material-removing processes, e.g. wire spark erosion or broaching, which each produce a sharp-edged transition and require a separate subsequent rounding step (e.g. by milling), this can allow the integration of process steps. Compared to electrochemical machining, in which a rounding would be set solely by changing the machining parameters, for example, the present approach can be advantageous in terms of accuracy, for example.

Preferred embodiments can be found in the dependent claims and the entire disclosure, whereby the description of the features does not always differentiate in detail between aspects of the device and aspects of the process or use; in any case, the disclosure is to be read implicitly with regard to all categories of claims. In particular, it relates equally to the method for forming the recess and also to a manufacturing method in which a component is made from the workpiece by forming the recess, in particular for a turbomachine or an aircraft engine.

The recess is formed in the workpiece starting from the first surface in an advance direction, so the first surface is the entry or starting surface. In general, the fully inserted recess does not have to extend through the workpiece, but can end inside it (like a blind hole). Preferably, however, it passes through the workpiece all the way to the opposite second side, i.e. it represents an exit or end surface. In this case, a protective anode assigned to the flank is preferably provided on both the first and the second surface, i.e. a first protective anode on the first surface and a second protective anode on the second surface. Where reference is made below generically to the “protective anode” and “at least one surface”, this should be read as referring to both the first protective anode/first surface and the second protective anode/second surface.

From a geometric point of view, the recess can be a prismatic contour that results from parallel displacement of an initial contour of the processing cathode in the advance direction. The advance direction is preferably perpendicular to the first and/or second surface. In general, the workpiece can also be separated by forming the recess, i.e. divided into separate parts: preferably, however, the workpiece remains an integrally connected part when the recess is formed.

The protective anode is in contact with the at least one surface of the workpiece (the first protective anode with the first and/or the second protective anode with the second surface), so there is an electrically conductive contact surface between them. In detail, the offset between the flank and the protective anode can then be taken between this contact surface and the flank, namely in a surface direction. When reference is generally made to a “surface direction”, this is parallel to the first and/or second surface and preferably perpendicular to the flank. In the surface direction, the flank limits the recess (and the protective anode is offset outwards).

The offset taken in the surface direction can, for example, be at least 0.1 mm in absolute values, preferably at least 0.2 mm, wherein possible upper limits can be, for example, at most 3 mm, 2.5 mm, 2 mm, 1.5 mm, 1 mm or 0.8 mm.

As mentioned, the flank and the at least one surface against which the protective anode rests preferably merge with a rounding. In the case of the first surface, this is introduced at the start of the removal process (“first rounding”), whereas on the second surface it is introduced when the processing cathode exits, i.e. at the end of the removal process (“second rounding”). Viewed in a sectional plane perpendicular to the flank and the at least one surface, the rounding preferably has an exclusively convex shape (e.g. without an inflection point or concave section). In a preferred embodiment, the rounding extends as far as the protective anode when viewed in the section, where it preferably merges tangentially into the at least one surface.

According to a preferred embodiment, the offset of the protective anode is not constant along the flank. The respective offset can, for example, be taken in a section perpendicular to the flank and the at least one surface at the respective location. The variation “along the flank” then means that the offset differs in at least some of the sectional planes (although there may also be sections with a constant offset despite the variation). In general, the varying offset can be used, for example, to specifically set a corresponding rounding values, i.e. a stronger rounding in a section with a larger offset and a smaller rounding in a section with a smaller offset.

In a preferred embodiment, however, the variation is used to compensate for varying removal behavior, i.e. a smaller offset is set in a section of the flank in which the removal behavior itself is increased (e.g. due to geometry or flow). On the other hand, in an area with a comparatively lower removal rate, a comparatively larger offset is set so that the offset compensates for the different removal rates and results in an essentially identical rounding. A “substantially” identical or constant rounding can mean in particular that it extends the same distance into the at least one surface and/or the flank, and the roundings observed in the respective sections are particularly preferably congruent.

According to a preferred embodiment, the protective anode encloses the flank when viewed from above over its entire extension outwards away from the recess (with varying or constant offset). The protective anode can preferably be a one-piece body, but generally also a segmented body.

The protective anode is made of an electrochemically stable material: in a preferred embodiment, the protective anode material is electrochemically more noble than the metallic material of the workpiece. Preferably, the protective anode can have at least one platinum coating (be platinized), particularly preferably it is made entirely of platinum. Irrespective of the implementation in detail, which can also depend on the metal of the workpiece, the protective anode preferably remains unchanged when the recess is formed, i.e. no material is removed from the protective anode. The protective anode is not cut through or dissolved when the recess is formed in the workpiece, so it can be used several times (for sequential machining of several workpieces).

In a preferred embodiment, a protective electrode is additionally arranged on the first and/or second surface next to the protective anode, electrically insulated from the protective anode and the workpiece. In particular, a first protective electrode can be provided on the first surface and a second protective electrode on the second surface. The respective protective electrode can be spaced and insulated from the respective surface via a solid insulator or, for example, an air gap. Viewed from above, an insulator (solid insulator) can be provided between the protective anode and the protective electrode. Like the workpiece and the protective anode, the protective electrode is or will be positively charged, but more strongly in relation to it. A higher electrical potential is therefore applied than to the workpiece, so that the electric field lines in the draining electrolyte channel are primarily formed between the processing cathode and the protective electrode, and not between the processing cathode and the first and/or second surface of the workpiece.

The term “draining electrolyte channel” refers to the electrolyte flow emerging from the working gap, which can lead to localized or even extensive unwanted removal or etching (so-called “pitting”) in surrounding areas, i.e. to parasitic stray removal. During removal, the first and second surfaces may already be in the machined state, in particular in the finished state, and any damage there would have to be reworked at great expense or, in the worst case, would lead to rejects. Preferably, both the first and second surfaces are protected.

In a preferred embodiment, the protective anode, the protective electrode and the insulator arranged between them completely cover a processing area of the workpiece. The “processing area” is the area outside the recess that can come into contact with the electrolyte during the insertion of the recess, i.e. is located inside a machining chamber.

In a preferred embodiment, a first protective anode is placed on the first surface and a second protective anode on the second surface (see above), each in electrically conductive contact. Preferably, both the first and the second protective anode are offset outwards with respect to the flank, i.e. a rounding is set in both the first and the second surface. In particular, the first and second surfaces can be parallel to each other, wherein the respective offset of the first and second protective anode can be the same or different in a respective sectional plane (perpendicular to the flank and to the first and second surfaces). The latter can, for example, compensate for a different removal behavior on the first and second surface, i.e. at the entry and exit, i.e. serve to set an essentially equal rounding (cf. the definitions above).

According to a preferred embodiment, the processing cathode is part of a processing tool, which also has a tool protection electrode. In relation to the advance direction, the processing cathode can be arranged at the front of the tool and the protection electrode behind it, with an insulator (solid-state insulator) preferably provided in between. The tool protection electrode is moved together with the processing cathode when the recess is made, e.g. as the material is progressively removed into the recess.

The tool protection electrode is charged with the same sign as the workpiece, but preferably with a higher electrical potential. This can, for example, reduce electric field lines on the already exposed section of the flank and thus prevent parasitic erosion there.

The invention also relates to a method for manufacturing a component for an axial flow machine, in particular for an aircraft engine. The component is manufactured from a workpiece into which a recess is formed in accordance with the present disclosure.

In a preferred embodiment, the recess is a profiled groove for form-fit reception of a complementary shape, in particular the component can be a rotor disk and the recess can be a blade foot receptacle. To produce a rotor stage, a blade foot can then be inserted into the receptable, the blade foot carrying the blade. A number of blades are provided in a consecutive sequence, so that a number of recesses/blade-foot holders are made in the disk. The method disclosed here can be advantageous in that the fillets can be introduced in a defined manner (reproducibility) and the amount of reworking or scrap is reduced accordingly, which could otherwise mean considerable costs, especially in view of the materials and size of a rotor disk.

The invention also relates to the use of a processing cathode and/or a protective anode in a method disclosed herein, e.g. the preparation thereof for the corresponding method.

The invention also relates to a device for making a recess in the manner described above. In particular, the device has the processing cathode and the protective anode, furthermore it is set up, for example, for displacing the processing cathode in an advance direction and has a processing chamber in which the workpiece can be arranged and surrounded by the electrolyte. The processing cathode and the protective anode are adapted to each other, namely have a complementary profile when viewed in a sectional plane perpendicular to the advance direction, with a distance between them corresponding to the offset. The profile defined by the protective anode is therefore slightly larger than that of the processing cathode.

The invention can also be summarized in terms of the following aspects:
1. aspect: A method for forming a recess in a workpiece,
wherein the recess is formed with a processing cathode by electrochemical removal, wherein a flank delimiting the recess is exposed with the removal, which flank extends from a first surface of the workpiece in direction to an opposite second surface of the workpiece,
wherein a protective anode is arranged on at least one of the surfaces during the removal, which protective anode is assigned to the flank and is in electrical contact with the workpiece at the at least one surface,
and wherein the protective anode is offset outwards relative to the flank, i.e. away from the recess.
2. aspect: The method according to aspect 1, wherein the at least one surface and the flank merge into one another with a rounding which, viewed in a section perpendicular to the flank and to the at least one surface, extends up to the protective anode.
3. aspect: The method according to aspect 1 or 2, wherein a respective offset which the protective anode has at a respective location from the flank varies along the flank.
4. aspect: The method according to aspect 3, wherein the at least one surface and the flank merge into one another at the respective location with a respective rounding, the rounding being basically constant along the flank.
5. aspect: The method according to any one of the preceding aspects, wherein the protective anode, as seen in a top view on the at least one surface, encloses the flank outwardly over the entire extension of the flank.
6. aspect: The method according to any one of the preceding aspects, wherein the protective anode is made of a material which is electrochemically more noble in relation to the workpiece.
7. aspect: The method according to any one of the preceding aspects, wherein a protective electrode is arranged at the at least one surface next to the protective anode, which protective electrode is electrically insulated from the protective anode and the workpiece.
8. aspect: The method according to aspect 7, wherein the at least one surface, in a processing area, is completely covered by the protective anode, the protective electrode and an insulator arranged therebetween.
9. aspect: The method according to any one of the preceding aspects, wherein the flank is assigned a protective anode on both sides, i.e. on the first and on the second surface of the workpiece.
10. aspect: The method according to any one of the preceding aspects, wherein the processing cathode is part of a processing tool which additionally comprises a tool protection electrode.
11. aspect: A method for manufacturing a component for an axial flow machine of a workpiece, wherein a recess is formed in the workpiece in a method according to any one of the preceding aspects.
12. aspect: The method according to aspect 11, wherein the recess is a profiled groove for receiving a complementary shape in a form locking manner.
13. aspect: The method according to aspects 11 or 12, wherein the component is a rotor disk and the recess is a blade foot receptacle.
14. aspect: A use of a processing cathode and/or a protective anode in a method according to any one of the preceding aspects.
15. aspect: Device for forming a recess in a workpiece, in particular in a method according to any one of aspects 1 to 10, which has a processing cathode for electrochemical removal in an advance direction and a protective anode for arrangement on at least one surface of a workpiece, wherein the processing cathode defines a profile in a plane perpendicular to the advance direction and the protective anode has a profile which is complementary thereto but larger.

### BRIEF DESCRIPTION OF THE DRAWINGS

Below, the invention is explained in more detail with reference to exemplary embodiments, wherein the individual features may also be relevant to the invention in other combinations within the scope of the independent claims and no distinction is made in detail between the different categories of claims.

In detail

FIG. 1 shows a schematic sectional view of a recess formed in a workpiece:

FIG. 2 is a detailed view of FIG. 1, at an earlier stage of the process:

FIG. 3 shows an arrangement with a modified offset compared to FIG. 2, to produce a stronger rounding:

FIG. 4 shows a top view of a protective anode used when forming a profiled groove:

FIG. 5 shows a schematic longitudinal section of an aircraft engine.

### PREFERRED EMBODIMENT OF THE INVENTION

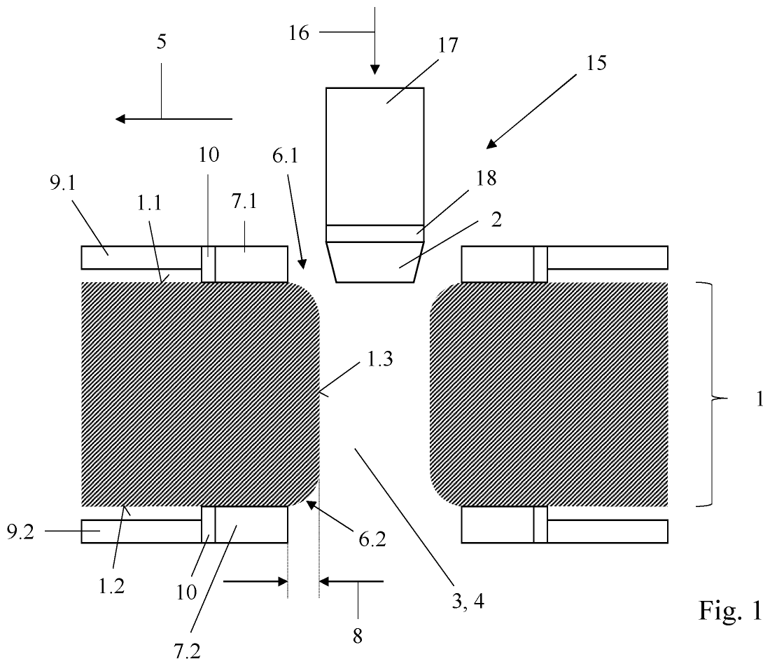

FIG. 1 shows a workpiece 1 in which a recess 3, in this case a through-hole 4, has been formed with a processing cathode 2. The recess 3 or the through-hole 4 was formed starting from a first surface 1.1 of the workpiece 1 (entry surface) until the processing cathode 2 has emerged from an opposite second surface 1.2 of the workpiece 1. FIG. 1 shows the processing cathode 2 after insertion, i.e. in a retracted state.

In a surface direction 5, the recess 3 is defined by a flank 1.3, which merges into the first and second surfaces 1.1, 1.2 with a rounding 6.1, 6.2. This defined rounding 6.1, 6.2 is set respectively with a protective anode 7.1, 7.2, which is respectively in contact with the respective surface 1.1, 1.2 in an electrically conductive manner. In detail, a first protective anode 7.1 is arranged on the first surface 1.1 and a second protective anode 7.2 on the second surface 1.2, wherein these are at the same electrical potential as the workpiece 1, i.e. are positively charged during the removal process. For the sake of clarity, the left half of FIG. 1 is predominantly referenced with reference signs, but the structure in the right half of the figure is identical, in particular symmetrical.

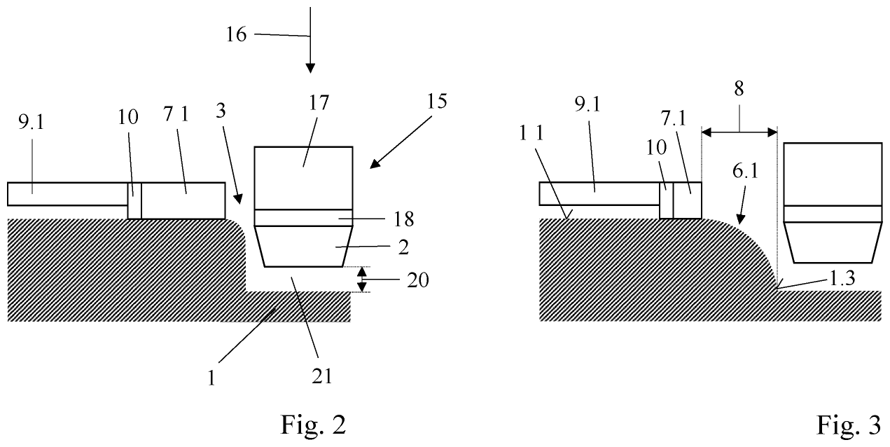

The protective anodes 7.1, 7.2, which are made of platinum in the present case, homogenize the field distribution and the desired rounding 6.1, 6.2 can be set in a targeted manner (see also FIGS. 2 and 3 for illustration). The latter is achieved by arranging the protective anodes 7.1, 7.2 not in alignment with the flank 1.3, but offset outwards in the surface direction 5 away from the recess 3. In the present case, a respective offset 8 on the first and second surfaces 1.1, 1.2 is identical, but it could also be set to different sizes.

Furthermore, a respective protective electrode 9.1, 9.2 is provided to protect the first and second surfaces 1.1, 1.2, namely a first protective electrode 9.1 on the first surface 1.1 and a second protective electrode 9.2 on the second surface 1.2.2. The protective electrodes 9.1, 9.2 are each insulated from the workpiece 1 and also from the protective anode 7.1, 7.2, the latter via a respective insulator 10. During machining, the protective electrodes 9.1, 9.2 are charged with the same sign as the workpiece 1, but with a higher potential. This can prevent parasitic stray erosion on the first and second surfaces 1.1, 1.2, see the description above in detail.

The processing cathode 2 is part of a processing tool 15, which is moved in the advance direction 16 during machining. The processing tool 15 also has a tool protection electrode 17, which is insulated from the processing cathode 2 by an insulator 18. During removal, a positive potential is applied to the tool protection electrode 17, which is higher than the one applied to the workpiece 1 and the protection anodes 7.1, 7.2, e.g. roughly comparable to that of the protection electrodes 9.1, 9.2. This can prevent parasitic erosion on the flank 1.3, for example.

FIG. 2 shows a process step prior to the one illustrated in FIG. 1, namely during the insertion of the recess 3. Between the processing cathode 2 and the workpiece 1, the material is removed in a working gap 20 in an electrolyte solution 21, which is not only present in the recess 3, but also flows around areas outside, which are therefore protected in a manner described above. In general, the same reference signs are used in this disclosure for the same parts or parts with the same function, and reference is also made to the explanations of the respective other figures.

FIG. 3 illustrates an arrangement in which the first protective anode 7.1 is provided with a greater offset 8 to the flank 1.3 compared to FIG. 2, meaning that a greater rounding 6.1 is achieved.

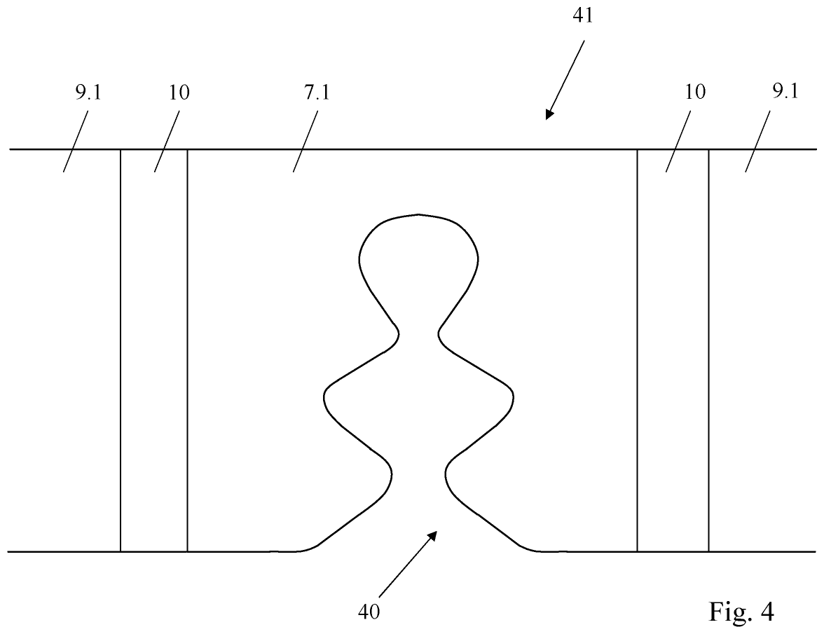

FIG. 4 shows the first protective anode 7.1 in a top view, which shows the design of the recess as a profiled groove 40 (e.g. so-called fir tree profile). A processing cathode with a complementary profile can then be used to create the corresponding recess, in this example as an axial profiled groove in a rotor disk. In addition to the first protective anode 7, the insulator 10 and the first protective electrode 9.1 can be seen in FIG. 4. Together with the first protective anode 7.1, these cover a processing area 41.

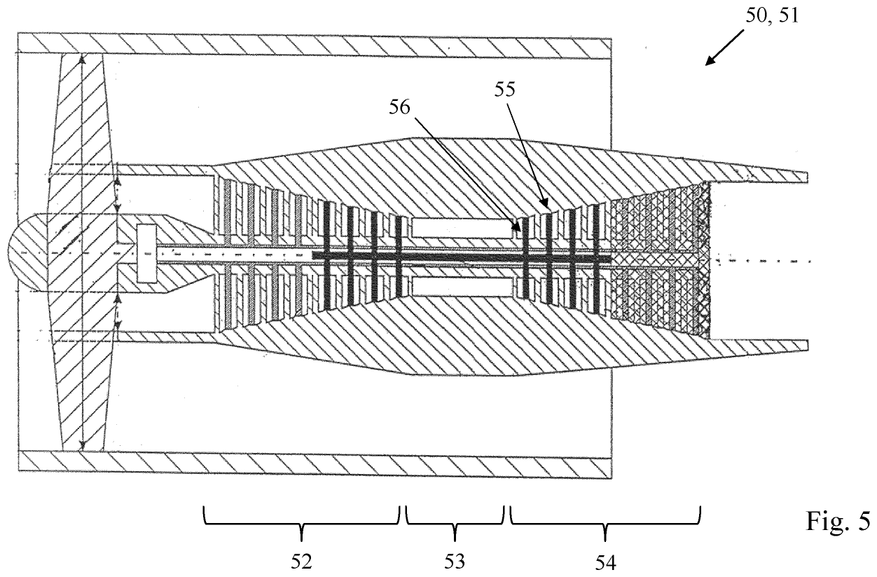

FIG. 5 shows a flow machine 50, in this case an aircraft engine 51, which is functionally divided into compressor 52, combustion chamber 53 and turbine 54. During operation, air drawn in is compressed in a compressor 52 and burned in the downstream combustion chamber 53 with added kerosene, wherein the resulting hot gas is expanded in a turbine 54. Both the compressor 52 and the turbine 54 each have several stages with a guide vane ring and a rotor blade ring. Such a rotor blade ring, referenced by way of example for the turbine 54 with the reference sign 55, can be constructed from a respective rotor disk 56, into which profile grooves 40 are introduced circumferentially distributed in a manner described above by electrochemical machining and subsequently fitted with rotor blades.

### REFERENCE LIST

Workpiece 1
First surface of the workpiece 1.1
Opposite second surface of the workpiece 1.2
Edge 1.3
Processing cathode 2
Recess 3
Through hole 4
Surface direction 5
Rounding 6.1, 6.2
First protective anode 7.1
Second protective anode 7.2
Offset 8
First protective electrode 9.1
Second protective electrode 9.2
Isolator 10
Processing tool 15
Advance direction 16
Tool protection electrode 17
Insulator (of the tool protection electrode) 18
Profile groove 40
Processing area 41
Flow machine 50
Aircraft engine 51
Compressor 52
Combustion chamber 53
Turbine 54
Reference sign 55
Rotor disk 56

1. A method for forming a recess in a workpiece,
wherein the recess is formed with a processing cathode by electrochemical removal,
wherein a flank delimiting the recess is exposed with the removal, which flank extends from a first surface of the workpiece in direction to an opposite second surface of the workpiece,
wherein a protective anode is arranged on at least one of the surfaces during the removal, which protective anode is assigned to the flank and is in electrical contact with the workpiece at the at least one surface,
and wherein the protective anode is offset outwards relative to the flank, away from the recess.

2. The method according to claim 1, wherein the at least one surface and the flank merge into one another with a rounding which, viewed in a section perpendicular to the flank and to the at least one surface, extends up to the protective anode.

3. The method according to claim 1, wherein a respective offset which the protective anode has at a respective location from the flank varies along the flank.

4. The method according to claim 3, wherein the at least one surface and the flank merge into one another at the respective location with a respective rounding, the rounding being basically constant along the flank.

5. The method according to claim 1, wherein the protective anode, as seen in a top view on the at least one surface, encloses the flank outwardly over the entire extension of the flank.

6. The method according to claim 1, wherein the protective anode is made of a material which is electrochemically more noble in relation to the workpiece.

7. The method according to claim 1, wherein a protective electrode is arranged at the at least one surface next to the protective anode, which protective electrode is electrically insulated from the protective anode and the workpiece.

8. The method according to claim 7, wherein the at least one surface, in a processing area, is completely covered by the protective anode, the protective electrode and an insulator arranged therebetween.

9. The method according to claim 1, wherein the flank is assigned a protective anode on both sides, on the first and on the second surface of the workpiece.

10. The method according to claim 1, wherein the processing cathode is part of a processing tool which additionally comprises a tool protection electrode.

11. A method for manufacturing a component for an axial flow machine of a workpiece, wherein a recess is formed in the workpiece in a method according to claim 1.

12. The method according to claim 11, wherein the recess is a profiled groove for receiving a complementary shape in a form locking manner.

13. The method according to claim 11, wherein the component is a rotor disk and the recess is a blade foot receptacle.

14. (canceled)

15. Device-A device for forming a recess in a workpiece, in particular in a method according to claim 1, which has a processing cathode for electrochemical removal in an advance direction and a protective anode for arrangement on at least one surface of a workpiece, wherein the processing cathode defines a profile in a plane perpendicular to the advance direction and the protective anode has a profile which is complementary thereto but larger.
